(19) United States
(12) Patent Application Publication
(10) Pub. No.: US 2022/0326642 A1
(43) Pub. Date: Oct. 13, 2022

(54) HEATER, AND IMAGE FORMING APPARATUS

(71) Applicant: Toshiba Lighting & Technology Corporation, Kanagawa (JP)

(72) Inventor: Kousuke UENO, Ehime-ken (JP)

(73) Assignee: Toshiba Lighting & Technology Corporation, Kanagawa (JP)

(21) Appl. No.: 17/672,666

(22) Filed: Feb. 15, 2022

(30) Foreign Application Priority Data
Apr. 12, 2021 (JP) 2021-066851

(51) Int. Cl. G03G 15/20; H05B 3/06

(52) U.S. Cl. CPC G03G 15/2053; H05B 3/06

(57) ABSTRACT

A heater includes: a substrate; a heating element, provided on a first surface of the substrate and extending in a longitudinal direction of the substrate; a protection part, provided on the first surface, extending in the longitudinal direction of the substrate, and covering the heating element; and at least one relaxation part, provided on a second surface of the substrate facing the first surface. A coefficient of thermal expansion of the protection part and a coefficient of thermal expansion of the at least one relaxation part are different from a coefficient of thermal expansion of the substrate. A material of the at least one relaxation part is the same as a material of the protection part, or a main component of the material of the at least one relaxation part is the same as a main component of the material of the protection part.

### CROSS-REFERENCE TO RELATED APPLICATIONS

This application claims the priority benefit of Japan Application No. 2021-066851, filed on Apr. 12, 2021. The entirety of the above-mentioned patent application is hereby incorporated by reference herein and made a part of this specification.

### BACKGROUND

### Technical Field

An embodiment of the disclosure relates to a heater and an image forming apparatus.

### Related Art

An image forming apparatus such as a copying machine or a printer is provided with a heater for fixing a toner. Generally, such a heater includes an elongated substrate, a heating element provided on one surface of the substrate and extending in a longitudinal direction of the substrate, and a protection part covering the heating element.

The substrate is made of a material having heat resistance, insulation properties, and high thermal conductivity. For example, the substrate is made of ceramics such as aluminum oxide, a metal core substrate in which a surface of a metal plate is coated with an insulating material, or the like.

The protection part is made of a material having heat resistance, insulation properties, high thermal conductivity, and high chemical stability. For example, the protection part is made of ceramics, glass, or the like.

Here, the material of the substrate and the material of the protection part may be different from each other. When the material of the substrate and the material of the protection part are different from each other, thermal stress may be generated due to a difference in coefficient of thermal expansion between the materials, and warpage my occur in the heater. In this case, the larger the difference in coefficient of thermal expansion between the substrate and the protection part, the more likely warpage is to occur.

When warpage occurs in the heater, there is a risk that a distance between the heater and an object to be heated may vary, and uneven heating may occur in the object to be heated.

Accordingly, it has been desired to develop a technique capable of suppressing the occurrence of warpage in the heater.
Patent Document 1: Japanese Patent Laid-open No. 2007-240606

### SUMMARY

The disclosure provides a heater in which the occurrence of warpage can be suppressed, and also provides an image forming apparatus.

A heater according to an embodiment includes: a substrate; a heating element, provided on a first surface of the substrate and extending in a longitudinal direction of the substrate; a protection part, provided on the first surface, extending in the longitudinal direction of the substrate, and covering the heating element; and at least one relaxation part, provided on a second surface of the substrate facing the first surface. A coefficient of thermal expansion of the protection part and a coefficient of thermal expansion of the at least one relaxation part are different from a coefficient of thermal expansion of the substrate. A material of the at least one relaxation part is the same as a material of the protection part, or a main component of the material of the at least one relaxation part is the same as a main component of the material of the protection part.

According to an embodiment of the disclosure, a heater in which the occurrence of warpage can be suppressed, as well as an image forming apparatus, can be provided.

### BRIEF DESCRIPTION OF THE DRAWINGS

FIG. 1 is a schematic front view for illustrating a heater according to the present embodiment.

FIG. 2 is a schematic back view for illustrating a heater.

FIG. 3 is a schematic sectional view of the heater in FIG. 1 along line A-A.

FIG. 4 is a schematic view for illustrating an image forming apparatus according to the present embodiment.

FIG. 5 is a schematic view for illustrating a fixing part.

### DESCRIPTION OF THE EMBODIMENTS

An embodiment is hereinafter illustrated with reference to the drawings. In each drawing, similar components are assigned the same reference numerals and detailed description thereof will be omitted as appropriate. Arrows X, Y, and Z in each drawing represent three directions orthogonal to each other. For example, the longitudinal direction of a substrate is set as the X direction, the lateral direction (width direction) of the substrate is set as the Y direction, and a direction perpendicular to a surface of the substrate is set as the Z direction.

(Heater)

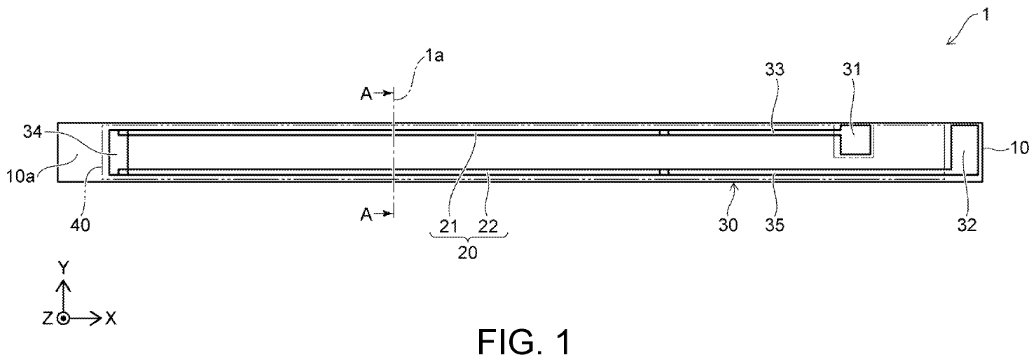

FIG. 1 is a schematic front view for illustrating a heater 1 according to the present embodiment.

FIG. 1 is a view of the heater 1 from a side where a heating part 20 and a protection part 40 are provided.

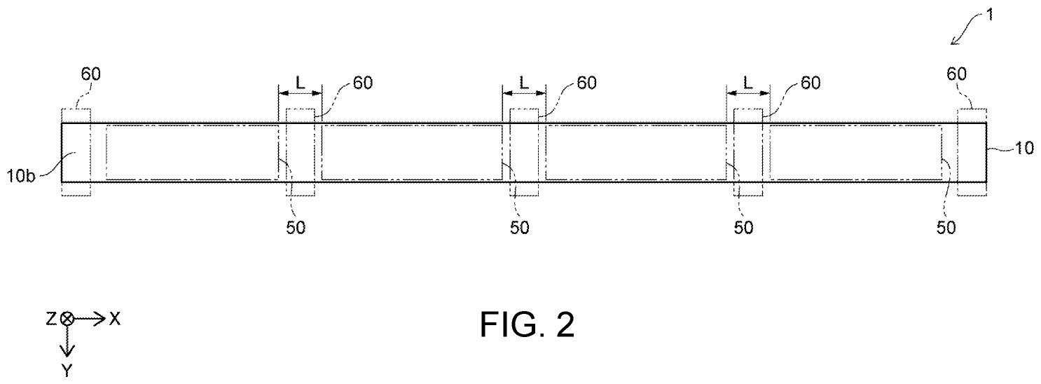

FIG. 2 is a schematic back view for illustrating the heater 1.

FIG. 2 is a view of the heater 1 from a side where a relaxation part 50 is provided.

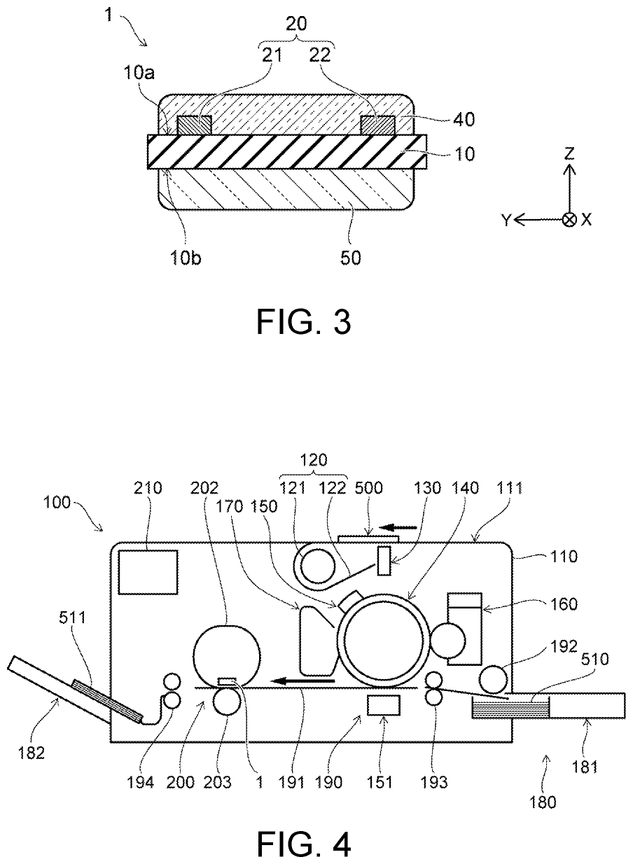

FIG. 3 is a schematic sectional view of the heater 1 in FIG. 1 along line A-A.

As shown in FIG. 1 to FIG. 3, the heater 1 includes, for example, a substrate 10, the heating part 20, a wiring part 30, the protection part 40, and the relaxation part 50.

The substrate 10 has a shape resembling a plate and extending in one direction (for example, X direction). The substrate 10 has a planar shape of, for example, an elongated rectangle. The substrate 10 has a thickness that can be set to, for example, about 0.5 mm to 1.0 mm. Planar dimensions of the substrate 10 can be appropriately changed depending on the size or the like of an object (for example, paper) to be heated.

The substrate 10 is made of a material having heat resistance, insulation properties, and high thermal conductivity. The substrate 10 is made of, for example, ceramics such as aluminum oxide or aluminum nitride, crystallized glass (glass ceramics), or a metal core substrate.

The metal core substrate has, for example, a metal plate made of stainless steel or the like, and an insulating layer covering a surface of the metal plate. The insulating layer can be formed of, for example, an inorganic material such as ceramics. The metal core substrate including the metal plate has higher thermal conductivity than ceramics or the like. Hence, if the substrate 10 is made of the metal core substrate, the occurrence of in-plane distribution in the temperature of the heater 1 can be suppressed.

The heating part 20 converts applied electric power into heat (Joule heat). The heating part 20 can be provided on a surface 10a (corresponding to an example of a first surface) of the substrate 10.

The heating part 20 includes, for example, a heating element 21 and a heating element 22. Although the case where the heating element 21 and the heating element 22 are provided is illustrated as an example, the number or size of the heating element can be appropriately changed depending on the size or the like of the object to be heated. Multiple kinds of heating elements that are different in length, width, shape or the like can also be provided. That is, it is sufficient that at least one heating element be provided.

The heating element 21 and the heating element 22 are, for example, provided side by side at a predetermined distance from each other in the Y direction (lateral direction of the substrate 10). The heating element 21 and the heating element 22 have, for example, a form extending along the X direction (longitudinal direction of the substrate 10).

Dimensions (lengths) of the heating element 21 and the heating element 22 in the X direction can be set, for example, substantially the same. In this case, the center of each of the heating element 21 and the heating element 22 is preferably located on a straight line 1a. That is, each of the heating element 21 and the heating element 22 is preferably provided so as to be axisymmetric with the straight line 1a as the axis of symmetry.

When the heater 1 is attached to an image forming apparatus 100, for example, the straight line 1a is made to overlap a center line of a conveyance path of the object to be heated. In this way, even if a change occurs in a dimension of the object to be heated in a direction orthogonal to a conveyance direction, it becomes easy to substantially uniformly heat the object to be heated.

Electrical resistance values of the heating element 21 and the heating element 22 can be set substantially the same or different. For example, by setting the dimension (length) in the X direction, the dimension (width) in the Y direction, and the dimension (thickness) in the Z direction substantially the same between the heating element 21 and the heating element 22, the electrical resistance values of the heating element 21 and the heating element 22 can be set substantially the same. By changing at least one of these dimensions, the electrical resistance values can be set different. By changing a material, the electrical resistance values can be set different.

The electrical resistance value per unit length of the heating element 21 can be set substantially uniform in the X direction. For example, the dimension (width) in the Y direction and the dimension (thickness) in the Z direction of the heating element 21 can be set substantially constant. A planar shape of the heating element 21 can be set, for example, a substantially rectangular shape extending along the X direction (longitudinal direction of the substrate 10).

The electrical resistance value per unit length of the heating element 22 can be set substantially uniform in the X direction. For example, the dimension (width) in the Y direction and the dimension (thickness) in the Z direction of the heating element 22 can be set substantially constant. A planar shape of the heating element 22 can be set, for example, a substantially rectangular shape extending along the X direction (longitudinal direction of the substrate 10).

The heating element 21 and the heating element 22 can be formed using, for example, ruthenium oxide (RuO₂), silver-palladium (Ag—Pd) alloy, or the like. The heating element 21 and the heating element 22 can be formed, for example, by applying a paste-like material on the substrate 10 by using a screen printing method or the like and curing the same by using a firing method or the like.

The wiring part 30 is provided, for example, on the surface 10a of the substrate 10 on which the heating part 20 (heating element 21 and heating element 22) is provided.

The wiring part 30 includes, for example, a terminal 31, a terminal 32, a wire 33, a wire 34, and a wire 35.

The terminals 31 and 32 are provided, for example, in the vicinity of one end of the substrate 10 in the X direction. The terminals 31 and 32 can be provided side by side in the X direction. The terminals 31 and 32 are electrically connected to, for example, a power supply or the like, via a connector and a wire or the like.

The wire 33 is provided, for example, on a side of the substrate 10 where the terminal 31 is provided in the X direction. The wire 33 has a form extending in the X direction. The wire 33 is electrically connected to the terminal 31 and an end of the heating element 21 on the terminal 31 side.

The wire 34 is provided, for example, in the vicinity of an end of the substrate 10 opposite the side where the terminals 31 and 32 are provided in the X direction. An end of the heating element 21 opposite the wire 33 side and an end of the heating element 22 opposite the wire 35 side are electrically connected to the wire 34.

The wire 35 is provided, for example, on a side of the substrate 10 where the terminal 32 is provided in the X direction. The wire 35 has a form extending in the X direction. The wire 35 is electrically connected to the terminal 32 and an end of the heating element 22 on the terminal 32 side.

The wiring part 30 (terminals 31, 32 and wires 33 to 35) is formed using a material containing, for example, silver or copper. For example, the terminals 31, 32 and the wires 33 to 35 can be formed, for example, by applying a paste-like material on the substrate 10 by using a screen printing method or the like and curing the same by using a firing method or the like.

The protection part 40 is provided, for example, on the surface 10a of the substrate 10 on which the heating part 20 is provided. The protection part 40 has, for example, a form extending along the X direction (longitudinal direction of the substrate 10). The protection part 40 covers the heating part 20 (heating elements 21 and 22) and a portion (wires 33 to 35) of the wiring part 30. In this case, the terminals 31 and 32 can be exposed from the protection part 40.

The protection part 40 has, for example, a function of insulating the heating part 20 and a portion of the wiring part 30, a function of transmitting the heat generated in the heating part 20, and a function of protecting the heating part 20 and a portion of the wiring part 30 from an external force or a corrosive gas or the like. The protection part 40 is made of a material having heat resistance, insulation properties, high chemical stability, and high thermal conductivity. The protection part 40 is made of, for example, ceramics, glass, or the like. In this case, the protection part 40 can also be made using glass to which a filler containing a material having high thermal conductivity, such as aluminum oxide, is added. The thermal conductivity of the glass to which the filler is added can be set to, for example, 2 [W/(m K)] or more.

The heater 1 may further be provided with a detector detecting a temperature of the heating part 20 (heating elements 21 and 22). The detector can be set as, for example, a thermistor. The detector can be provided on at least one of the surface 10a of the substrate 10 on which the heating part 20 is provided and a surface 10b (corresponding to an example of a second surface) of the substrate 10 opposite the side where the heating part 20 is provided. For example, a wire and a terminal electrically connected to the detector are provided on the surface of the substrate 10 on which the detector is provided. For example, the detector and the wire can be covered by the protection part 40, and the terminal can be exposed from the protection part 40.

Here, as mentioned above, the substrate 10 is made of, for example, ceramics such as aluminum oxide or aluminum nitride, crystallized glass (glass ceramics), or a metal core substrate. On the other hand, the protection part 40 is made of, for example, ceramics, glass, or glass to which a filler is added.

Hence, the substrate 10 may have a coefficient of thermal expansion different from that of the protection part 40. During use of the heater 1, when the heater 1 generates heat, the substrate 10 and the protection part 40 are heated. During manufacture of the heater 1, when the protection part 40 is fired, the substrate 10 and the protection part 40 are heated. Hence, during use or manufacture of the heater 1, thermal stress may be generated due to a difference in coefficient of thermal expansion between the materials, and warpage my occur in the heater 1.

In this case, if the substrate 10 has a short length in the lateral direction (width direction, for example, Y direction), or the substrate 10 has a long length in the longitudinal direction (for example, X direction), or the substrate 10 has a small thickness, warpage is likely to occur in the heater 1. In a metal core substrate, since a metal plate serves as a base, the coefficient of thermal expansion of the metal core substrate is greater than that of an inorganic material such as ceramics or crystallized glass. Hence, if the substrate 10 is a metal core substrate, since a difference in the coefficient of thermal expansion increases, there is a risk that warpage may be relatively likely to occur in the heater 1, or relatively large warpage may occur in the heater 1.

When warpage occurs in the heater 1, there is a risk that a distance between the heater 1 and the object to be heated may vary, and uneven heating may occur in the object to be heated.

Accordingly, the heater 1 is provided with the relaxation part 50.

As shown in FIG. 2 and FIG. 3, the relaxation part 50 is provided on the surface 10b of the substrate 10 facing the surface 10a. When viewed from a direction (Z direction) perpendicular to the surface 10a (10b) of the substrate 10, at least a portion of the relaxation part 50 overlaps the protection part 40.

At least one relaxation part 50 can be provided. If multiple relaxation parts 50 are provided, as shown in FIG. 2, the multiple relaxation parts 50 can be provided side by side in the longitudinal direction (X direction) of the substrate 10.

The relaxation part 50 has a coefficient of thermal expansion different from that of the substrate 10. If the coefficient of thermal expansion of the relaxation part 50 is different from the coefficient of thermal expansion of the substrate 10, thermal stress is generated due to the difference in coefficient of thermal expansion between the materials during use or manufacture of the heater 1.

However, since the relaxation part 50 is provided on the surface 10b of the substrate 10 opposite the surface 10a on which the protection part 40 is provided, the thermal stress generated by the substrate 10 and the protection part 40 can be canceled out by the thermal stress generated by the substrate 10 and the relaxation part 50. If the thermal stress is canceled out, the occurrence of warpage in the heater 1 can be suppressed.

That is, if the relaxation part 50 is provided, the occurrence of warpage in the heater 1 can be suppressed.

In this case, the magnitude of the thermal stress generated by the substrate 10 and the relaxation part 50 is preferably set as equal as possible to the magnitude of the thermal stress generated by the substrate 10 and the protection part 40. Hence, the coefficient of thermal expansion of the relaxation part 50 is preferably set the same as or close to the coefficient of thermal expansion of the protection part 40. For example, a material of the relaxation part 50 can be set the same as a material of the protection part 40. For example, a main component of the material of the relaxation part 50 can be set the same as a main component of the material of the protection part 40. In this case, if the material of the relaxation part 50 is the same as the material of the production part 40, the manufacturing process can be simplified, the productivity can be improved, the manufacturing cost can be reduced, and so on.

By changing at least one of planar dimensions and thickness of the relaxation part 50, the occurrence of warpage can be suppressed, or the magnitude of warpage can be reduced. However, when a difference between the volume of the relaxation part 50 and the volume of the protection part 40 increases, the effect of canceling out the thermal stress is reduced. Hence, for example, if the material of the relaxation part 50 is the same as the material of the protection part 40, or if the main component of the material of the relaxation part 50 is the same as the main component of the material of the protection part 40, the volume of the relaxation part 50 is preferably set about the same as the volume of the protection part 40. For example, in the case where the volume of the protection part 40 is set to V1 mm³ and the volume of the relaxation part 50 is set to V2 mm³, preferably, “0.9≤V2/V1≤1.1”, and more preferably, “0.94≤V2/V1≤1.06”.

If multiple relaxation parts 50 are provided, by changing at least one of arrangement position, material, and volume (planar dimensions, thickness) of the multiple relaxation parts 50, the occurrence of warpage can be suppressed or the magnitude of warpage can be reduced. The arrangement position, material, and volume of the multiple relaxation parts 50 can be appropriately determined by conducting an experiment or a simulation.

If multiple relaxation parts 50 are provided, as shown in FIG. 2, a space can be provided between each of the relaxation parts 50. If the space is provided between each of the relaxation parts 50, a jig 60 can be provided in the space when the heater 1 is manufactured. If the jig 60 is provided in the space, for example, when multiple relaxation parts 50 are fired, bending of the substrate 10 can be suppressed. Hence, when the heater 1 is manufactured, deformation of the heater 1 can be suppressed.

However, when a distance L between each of the relaxation parts 50 increases, the effect of canceling out the thermal stress is reduced. Hence, the distance L between each of the relaxation parts 50 is preferably set to 7 mm or less. For example, if the distance L is set to about 5 mm, reduction in the effect of canceling out the thermal stress can be suppressed, and arrangement of the jig 60 is facilitated.

(Image Forming Apparatus)

Next, the image forming apparatus 100 provided with the heater 1 is illustrated.

In the following, a case where the image forming apparatus 100 is a copying machine is described as an example. However, the image forming apparatus 100 is not limited to a copying machine, and may be any apparatus provided with a heater for fixing a toner. For example, the image forming apparatus 100 can be set as a printer or the like.

FIG. 4 is a schematic view for illustrating the image forming apparatus 100 according to the present embodiment.

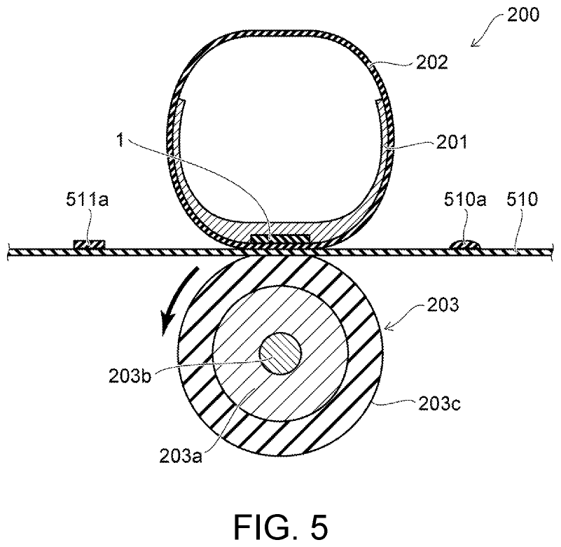

FIG. 5 is a schematic view for illustrating a fixing part 200.

As shown in FIG. 4, the image forming apparatus 100 includes, for example, a frame 110, an illumination part 120, an imaging element 130, a photosensitive drum 140, a charging part 150, a discharging part 151, a development part 160, a cleaner 170, a storage 180, a conveyance part 190, the fixing part 200, and a controller 210.

The frame 110 has a box shape, inside which the illumination part 120, the imaging element 130, the photosensitive drum 140, the charging part 150, the development part 160, the cleaner 170, a portion of the storage 180, the conveyance part 190, the fixing part 200 and the controller 210 are stored.

A window 111 made of a light transmissive material such as glass can be provided on an upper surface of the frame 110. A manuscript 500 to be copied is placed on the window 111. A movement part that moves the position of the manuscript 500 can be provided.

The illumination part 120 is provided in the vicinity of the window 111. The illumination part 120 includes, for example, a light source 121 such as a lamp, and a reflector 122.

The imaging element 130 is provided in the vicinity of the window 111.

The photosensitive drum 140 is provided below the illumination part 120 and the imaging element 130. The photosensitive drum 140 is rotatably provided. For example, a zinc oxide photosensitive layer or an organic semiconductor photosensitive layer is provided on a surface of the photosensitive drum 140.

The charging part 150, the discharging part 151, the development part 160 and the cleaner 170 are provided around the photosensitive drum 140.

The storage 180 includes, for example, a cassette 181 and a tray 182. The cassette 181 is detachably attached to one side part of the frame 110. The tray 182 is provided on a side part of the frame 110 opposite the side where the cassette 181 is attached. Paper 510 (for example, blank paper) before copying is stored in the cassette 181. Paper 511 on which a copy image 511a is fixed is stored in the tray 182.

The conveyance part 190 is provided below the photosensitive drum 140. The conveyance part 190 conveys the paper 510 between the cassette 181 and the tray 182. The conveyance part 190 includes, for example, a guide 191 supporting the paper 510 to be conveyed, and conveyance rollers 192 to 194 conveying the paper 510. The conveyance part 190 can be provided with a motor that rotates the conveyance rollers 192 to 194.

The fixing part 200 is provided on a downstream side (tray 182 side) of the photosensitive drum 140.

As shown in FIG. 5, the fixing part 200 includes, for example, the heater 1, a stay 201, a film belt 202, and a pressure roller 203.

The heater 1 is attached to a side of the stay 201 toward a conveyance line of the paper 510. The heater 1 can be embedded in the stay 201. In this case, the side of the heater 1 where the protection part 40 is provided is exposed from the stay 201.

The film belt 202 covers the stay 201 provided with the heater 1. The film belt 202 may contain a heat-resistant resin such as polyimide.

The pressure roller 203 is provided so as to face the stay 201. The pressure roller 203 includes, for example, a core 203a, a drive shaft 203b, and an elastic part 203c. The drive shaft 203b protrudes from an end of the core 203a and is connected to a drive apparatus such as a motor. The elastic part 203c is provided on an outer surface of the core 203a. The elastic part 203c is made of an elastic material having heat resistance. The elastic part 203c may contain, for example, a silicone resin.

The controller 210 is provided inside the frame 110. The controller 210 includes, for example, a calculation part such as a central processing unit (CPU), and a storage part storing a control program. The calculation part controls operation of each element provided in the image forming apparatus 100 based on the control program stored in the storage part. The controller 210 may also include an operation part for a user to input a copying condition or the like, a display part displaying an operating state or an abnormality, or the like.

Since a known technique is applicable to the control of each element provided in the image forming apparatus 100, detailed description thereof will be omitted.

Although several embodiments of the disclosure have been illustrated above, they are presented as examples and are not intended to limit the scope of the disclosure. These embodiments can be implemented in various other forms, and various omissions, replacements, and changes can be made without departing from the gist of the disclosure. These embodiments or modifications thereof are included in the scope or gist of the disclosure, as well as in the scope of the disclosure described in the claims and the equivalent scope thereof. Each of the above-described embodiments can be implemented in combination with each other.

What is claimed is:

1. A heater comprising:
a substrate;
a heating element, provided on a first surface of the substrate and extending in a longitudinal direction of the substrate;
a protection part, provided on the first surface, extending in the longitudinal direction of the substrate, and covering the heating element; and
at least one relaxation part, provided on a second surface of the substrate facing the first surface, wherein
a coefficient of thermal expansion of the protection part and a coefficient of thermal expansion of the at least one relaxation part are different from a coefficient of thermal expansion of the substrate;
a material of the at least one relaxation part is the same as a material of the protection part, or a main component of the material of the at least one relaxation part is the same as a main component of the material of the protection part.

2. The heater according to claim 1, wherein
a plurality of the at least one relaxation part are provided;
a distance between each of the plurality of the at least one relaxation part is 7 mm or less.

3. The heater according to claim 1, wherein
when volume of the protection part is set to V1 mm³, and volume of the at least one relaxation part is set to V2 mm³, 0.9≤V2/V1≤1.1.

4. An image forming apparatus comprising the heater according to claim 1.
